(19) United States
(12) Patent Application Publication
(10) Pub. No.: US 2006/0282294 A1
(43) Pub. Date: Dec. 14, 2006

(54) Supplemental crop insurance and method for providing risk protection to a grower

(76) Inventors: Shawn James McComb, Algonquin, IL (US); George Bailey Muehlbach, Fort Collins, CO (US); Dermot James Hayes, Ames, IA (US); Bruce Alan Babcock, Ames, IA (US); Claudio J. Martinez, Elgin, IL (US)

Correspondence Address: DEERE & COMPANY, ONE JOHN DEERE PLACE, MOLINE, IL, 61265, US

(21) Appl. No.: 11/149,680

(22) Filed: Jun. 9, 2005

(51) Int. Cl. G06Q 40/00

(52) U.S. Cl. 705/4

(57) ABSTRACT

A method for providing risk protection to a grower of a crop comprises reviewing a first crop insurance policy covering a first risk associated with an average yield of a group of growers. An insurer receives an assignment of at least a portion of the indemnification under the first crop insurance policy. An insurer issues a second crop insurance policy in exchange for the assigned indemnification to the first crop insurance policy. The second crop insurance policy covers a second risk associated with an average yield of an individual grower within the group of growers.

### FIELD OF THE INVENTION

This invention relates to a supplemental crop insurance product and a method for providing risk protection to a grower.

### BACKGROUND OF THE INVENTION

Farmers use group crop insurance to reduce or manage various risks associated with growing crops. Such risks include loss caused by weather, hail, drought, frost damage, insects, or disease, for instance. However, many group crop insurance policies only pay in the event that a loss reduces an average yield of a particular geographic area (e.g., a county), as opposed to the loss of yield or revenue of an individual grower. Accordingly, farmers have a need for crop insurance to cover the individualized risk of growing crops or a combination of individualized risk and group risk.

### SUMMARY OF THE INVENTION

A method of reducing the risk of a grower of a crop comprises reviewing a first crop insurance policy covering a first risk associated with a group performance (e.g., an average yield or average revenue) of a group of growers. An insurer receives an assignment of at least a portion of the indemnification under the first crop insurance policy. An insurer issues a second crop insurance policy in exchange for the assigned indemnification to the first crop insurance policy. The second crop insurance policy covers a second risk associated with individual performance (e.g., an average yield or revenue-based target) of an individual grower within the group of growers.

### Brief Description of the Drawings

FIG. 1 is a flow chart of a first embodiment of a method for providing risk protection for a grower of a crop.

FIG. 2 is a flow chart of a second embodiment of a method for providing risk protection for a grower of a crop.

FIG. 3 is a flow chart of a third embodiment of a method for providing risk protection for a grower of a crop.

FIG. 4 is a flow chart of a fourth embodiment of a method for providing risk protection for a grower of a crop.

FIG. 5 is an illustrative diagram of an insurance product, which may be used to provide a blend of group risk protection and individualized risk protection.

FIG. 6 is a graph that illustrates the targeted risk coverage of a supplemental crop insurance.

### DESCRIPTION OF THE PREFERRED EMBODIMENT

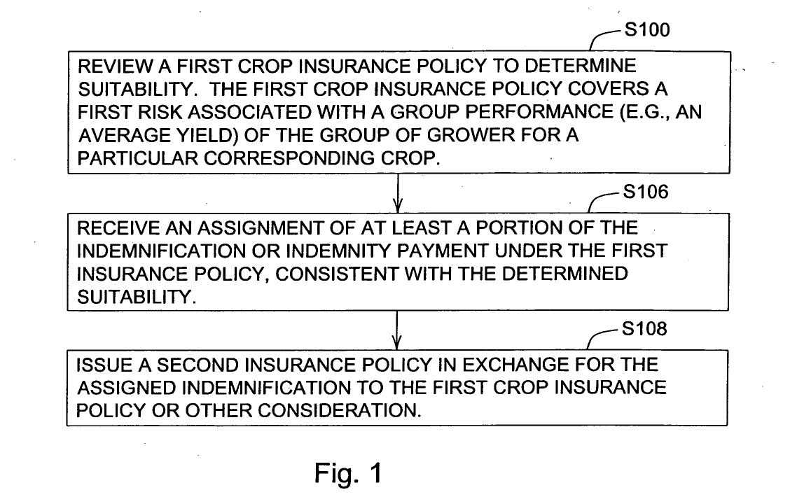

In accordance with one embodiment of the invention, FIG. 1 illustrates a method for providing risk protection for a grower of a crop. The method of FIG. 1 begins in step S100.

In step S100, an insurer, insurance agent, managing general agent or another reviews a first crop insurance policy to determine suitability (e.g., grower eligibility) for association with individualized protection for grower risk. For example, if the first insurance policy or indemnification (e.g., indemnity payment) for group risk is suitable for a partial or complete exchange with crop insurance coverage for individualized risk, the first crop insurance policy may be regarded as suitable.

Step S100 may be carried out in accordance with various techniques, that may be applied alternately or cumulatively. Under a first technique, the first crop insurance generally covers a first risk associated with group performance (e.g., an average yield) of a group of growers for a particular corresponding crop within a defined geographic area (e.g., a county). For example, the first crop insurance policy may cover the risk that group performance (e.g., an average county yield or mean county yield) for a particular crop for the defined geographic area (e.g., a particular county) in which the insured grower grows crops falls below a benchmark group performance (e.g., historic average county yield or historic average county yield performance, possibly adjusted for recent yield trends) for the defined geographic area. Yield trends may consider the impact and degree of adoption of agricultural technological improvements relevant to a particular crop in a defined geographic area. Yield trends may depend upon the adoption rate of certain advanced technologies; improved plant genetics to resist disease and pests; and improved crop inputs to reduce cost of application or to increase effectiveness of application of the crop inputs.

Under a second technique for executing step S100, the first crop insurance policy comprises a Group Risk Protection Policy (GRP). GRP is a risk management tool that protects against widespread loss where yields are generally low within a defined geographic area (e.g., county) in which the grower grows a particular crop. Group Risk Protection (GRP) protects against yield risks that are affected by covered natural disasters (e.g., drought) based on a county yield, instead of a grower's historic yield. The GRP may be preferred by growers with yields that tend to track the county yield and where a drought or other covered nature disaster tends to affect a substantial portion of a county. GRP indemnifies or pays out the insured grower if the county average per acre yield (referred to as the “payment yield”) falls below the insured grower's trigger yield (Y_{T}). Under current practices, the Federal Crop Insurance Corporation (FCIC) notifies or publishes the payment yield to all insurance providers for each county, following each growing season or crop year. The trigger yield (Y_{T}) means the expected county yield (Y_{c}) listed in the actuarial document multiplied by the coverage level percent (C) listed on the accepted application or first crop insurance policy. In other words, the following equation applies Y_{T} =Y_{C ×C}, where Y_{T} is the trigger yield, Y_{c} is the expected county yield, and C is the coverage level percent.

The expected county yield may represent an average of annual National Agricultural Statistics Service (NASS) county yields. The NASS county yields may or may not be adjusted for yield trends, as is appropriate under the circumstances or required by laws or other regulations. Under certain policies, the grower may select a coverage level of from approximately sixty percent to approximately one hundred percent of the maximum protection per acre. For a GRP policy as the first crop insurance policy, a grower may have a low yield on his farm and not receive a payment under the GRP policy because the policy is based on county yields, not individual grower yields. The inability of the GRP to provide any individualized risk protection may leave a grower exposed to considerable risk and losses without the supplemental crop insurance and method of this invention.

Under a third technique for executing step S100, the first crop insurance policy comprises a Group Risk Protection Income Protection (GRIP) policy. A Group Risk Income Protection (GRIP) policy is similar to a GRP policy, except the GRIP protects against general loss of revenue in a geographic area (e.g., county), as opposed to general yield shortfall in the geographic area. For example, under a GRIP policy the insured grower may receive a payment from the insurer where the county revenue falls below the insured grower's trigger revenue for the county. For GRIP, under current practices the expected market price is generally set each year or growing season by the U.S.D.A. Risk Management Agency (RMA). For example, the RMA might take an average futures price (e.g., closing prices or final daily settlement prices on the Chicago Board of Trade (CBOT) for a number of business days (e.g., 5 business days) prior to a target date (e.g., March 1 or March 15) for certain crop future contracts (e.g., December corn futures contract and November soybeans contract). For GRIP, the trigger revenue (R_{T}) may be determined in accordance with the following equation: R_{T}=Y_{C}×P_{E}×C, where R_{T} is the trigger revenue (e.g., expressed in revenue/land unit), Y_{c} is the expected county yield, P_{E} is the expected county price, and C is the coverage level in percent. Under a GRIP policy as the first crop insurance policy, when the actual county revenue falls below the trigger revenue, a payment is made to an insured grower in the county, regardless of that grower's revenue. For a GRIP policy as the first insurance policy, a grower may have low revenue on his farm and not receive a payment under the first policy because the policy is based on county revenue, and not individual grower revenue.

Under a fourth technique for executing step S100, the first policy may comprise a GRIPHRO or its equivalent. GRIPHRO refers to Group Risk Income Protection with Harvest Revenue Option; and provides some degree of group risk revenue protection based upon growers in a geographic area (e.g., county).

Under a fifth technique for executing step S100, the first risk means a risk associated with a revenue of a group of growers, an average revenue of a group of growers, a revenue per land unit (e.g., dollars per acre of revenue) for the growers associated with geographic area (e.g., a county), or an average revenue per land unit for the growers associated with a geographic area.

In step S106, the insurer receives an assignment of at least a portion of the indemnification or indemnity payment under the first insurance policy, consistent with the determined suitability. For example, the insurer receives an assignment of at least a portion of the indemnification or indemnity payment if the grower is eligible. The assigned portion may range from a portion to all of the indemnification or indemnity payment under the first crop insurance policy. The assigned portion may be defined in terms of one or more of the following, subject to the terms and conditions of the first crop insurance policy, applicable laws, and regulations: (1) an assigned percentage of the indemnification or indemnity payment of the first crop insurance policy, (2) an assignment of any portion of the indemnity payment coupled with a modification of the trigger yield or portion thereof under a GRP policy, (3) an assignment of any portion of the indemnity payment coupled with a modification of the trigger revenue or portion thereof under a GRIP policy, (4) an assignment of any portion of the indemnity payment associated with a modification of the monetary (e.g., dollar) protection level per land unit (e.g., acre) or portion thereof under the GRP policy based on an average futures price on a futures exchange or commodities exchange or fair market value for the particular crop, (5) an assignment of any portion of the indemnity payment associated with a modification to the monetary (e.g., dollar) protection level or portion thereof per land unit (e.g., acre) under the GRIP policy based on an average futures price or a futures exchange or commodities exchange or fair market value for the particular crop, (6) an assignment of any portion of the indemnity payment associated with a certain number of acres of a particular crop (or portion of a grower's total acres) covered by the GRP policy, the GRIP policy, or another first crop insurance policy and (7) an assigned complete or fractional interest in any indemnity payment received under the first crop insurance policy.

In step S108, the insurer issues a second insurance policy in exchange for the assigned indemnification or assignment of the indemnity payment under the first crop insurance policy. Although the insurer may issue the second insurance policy in consideration for the assigned indemnification or assignment of the indemnity payment, the insurer may issue the second insurance policy for other or additional consideration. The second crop insurance policy covers a second risk associated with an individual performance (e.g., an average yield or individual revenue) of an individual grower within the group of growers for the defined geographic area (e.g., a county).

The desired level of protection under the second crop insurance policy may be based upon a particular grower's historic yield, another analysis of historic grower performance, or an analysis of future grower performance. The grower's historic yield may be defined in terms of a grower's actual production history (APH).

The second insurance policy may have, but need not have, any of the following features of a Multiple Peril Crop Insurance (MPCI) program, or its equivalent, as described in this paragraph, or otherwise then in effect. An MPCI policy protects against yield risk of an individual grower that are affected by natural disasters. Catastrophic Risk Protection (CAT) is generally the lowest level of MPCI coverage. MPCI and other policies based on Actual Production History (APH) may, but need not, have the following coverage exclusions: (1) hail and fire exclusion provisions and (2) high risk land exclusion provisions. MPCI and other policies based on APH may have, but need not have, the following coverage requirements or limitations: (1) late planting provisions, (2) replant requirements, (3) replanting payment provisions, (4) prevented planting provisions, (5) nonstandard classification of growers or particular crop, and (6) grower experience adjustment factors. A gap policy, called crop-hail insurance, can fill the gap for damage that is less than the deductible of a basic MPCI policy. Crop-hail insurance may provide acre-by-acre coverage against hail damage, whereas an MPCI policy may only protect against widespread hail damage that materially effects a grower's overall yield.

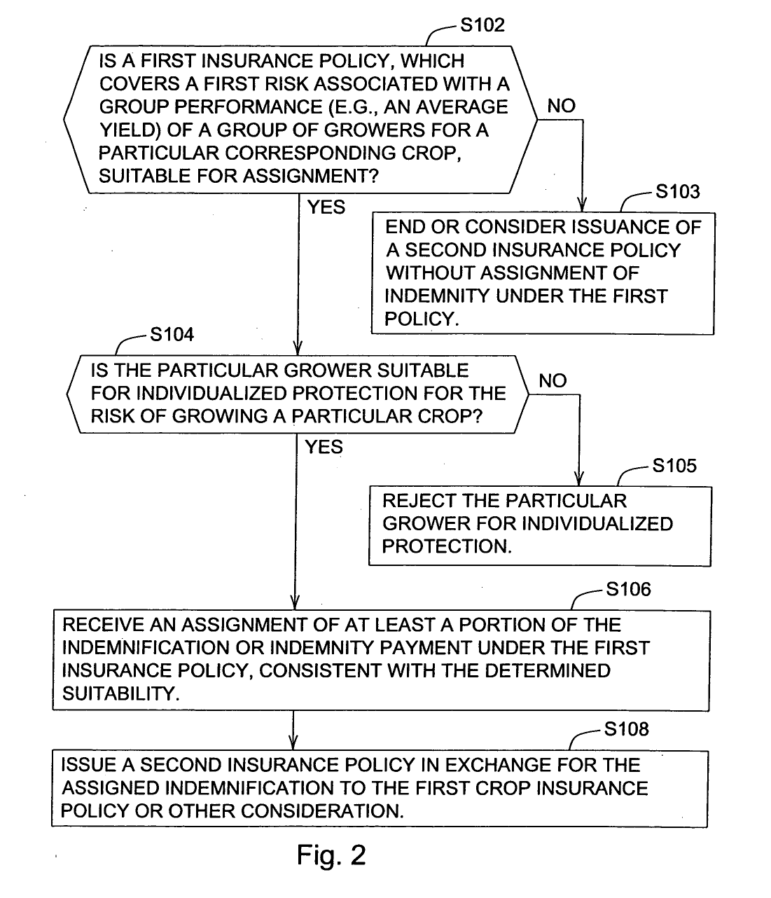

The method of FIG. 2 is similar to the method of FIG. 1, except the method of FIG. 2 replaces step S100 with steps S102, S103, S104, and S105. Like reference numbers in FIG. 1 and FIG. 2 indicate like steps or procedures.

In step S102, the insurer, insurance agent, managing general agent, or another determines whether the first insurance policy is suitable for assignment. The review of the first insurance policy in step S102 may determine one or more of the following factors for suitability of the first crop insurance policy: (1) whether all or part of the indemnification or indemnity payment or indemnity payment of the first crop insurance policy is assignable, and (2) what terms and conditions, restrictions, legal and regulatory requirements apply to assignment of all or part of the indemnification or indemnity payment. For example, the assignment may be unrestricted, restricted to a particular class or group of assignees, or prohibited altogether, depending upon the language of the first insurance policy. For example, unless allowed by the GRP policy, the insured grower cannot insure the same crop through both an MPCI policy and GRP policy. A grower is not generally required to maintain or report yield history for GRP policies. If the first insurance policy is determined to be suitable for assignment, the method continues with step S104. However, if the first insurance policy is determined to be unsuitable for assignment, the method continues in step S103.

In step S103, the method ends or the following alternative is considered. Under the alternative, the issuance of a second insurance policy is considered, where the second insurance policy is without the assignment of indemnity under the first policy. Here, the second policy may be issued for consideration other than the assignment of the indemnity payment under the first crop insurance policy, provided that the first crop insurance policy does not prohibit the grower from securing protection under the first policy (to protect against group risk) and the second policy (to protect against individual risk to an individual grower).

In step S104, the insurer, insurance agent, managing general agent or another determines if the particular grower is suitable for individualized risk protection or a certain level of individualized risk protection based on the particular grower's risk of growing a particular crop in accordance with applicable laws and regulations. The review of step S104 may determine one or more of the following factors for suitability of the particular grower for individualized protection of the grower's risk of growing a particular crop: (1) whether the grower having the first insurance policy has sufficient historic yield data available to predict or estimate future performance applicable to the time frame in which the second crop insurance policy is or would be in effect; (2) whether the grower's historic yield data or historic performance is consistent with a mean historic yield, mode historic yield, or both for a geographic region (e.g., a region of uniform grower or crop performance characteristics) of the group of growers; (3) the degree of variance, if any, between the grower's historic yield data or historic performance relative to the mean historic performance for a particular county or geographic region; and (4) genetic makeup or genetic profile of the particular crop to be covered by the second insurance policy, the environment (e.g., geographic area) associated with the grower's fields, and the agronomic management practices of the grower to be covered by the second insurance policy.

The historic yield data of a geographic region may be publicly available data such as the yield data that is available on a crop-by-crop basis for various counties. For instance, the historic yield data may comprise county yield data of the National Agricultural Statistics Database. The grower seeking insurance coverage may be required to provide historic yield data. The grower-provided historic yield data may be cross-checked against historic yield data for the applicable geographic area to determine if the grower-provided historic yield data is consistent with average yield in the applicable geographic area. Further, the grower-provided historic yield data may be cross-checked against the historic yield data of a reference model grower or a grower located in applicable geographic area or a substantially similar area.

In step S104, the variation of crop yield for a particular grower may depend upon genetic factors, environmental factors, and management practices applied to growing a particular crop. The grower's performance on crop yield may be screened by applying a coefficient of variation (Cᵥ). For example, the following equation may be used to describe the performance of a particular grower:

$${C}_{V} = \frac{100 σ}{\overline{z}} ,$$

where C_{V} is the coefficient of variation, σis the standard deviation of the sample population and \overline{z} is the mean. Further,

$${σ}^{2} = {\sum }_{i = 1}^{n} \frac{{( {z}_{i} - \overline{z} )}^{2}}{n - 1} ,$$

where z₁ through Zₙ are samples 1 through n.

The genetic factors may comprise one or more of the following items: plant variety, genetic structure, gene sequences, genetic expression, and DNA (deoxyribonucleic acid) structure of the crop. The genetic factors may influence traits such as drought tolerance, disease resistance, pest resistance, herbicide resistance or tolerance, yield, minimum growing degree days, and period from planting date to harvest date, among other things.

Environmental data may include soil data, soil survey data, weather data, climate data, field boundary data, field location data, or other geographic data on the grower's fields. The soil survey data may include, but is not limited to, the following soil parameters: soil texture, sand content, silt content, clay content, soil structure, bulk density, soil organic matter content, soil moisture, water holding capacity, available water capacity, nitrogen (N) level, phosphorus (P) level, potassium (K) level, nutrient levels, micronutrient levels, trace element levels, mineral levels, soil pH (e.g., level of acidity or alkalinity), and cation-exchange capacity. The available water capacity is the capacity of a soil to hold water available for plants. The available water capacity may be expressed as inches of water per a certain soil depth.

Climate data refers to data on expected long-term weather patterns. Predictive climate data may be based on historical data. Climate data may include precipitation (e.g., rainfall per unit time or rainfall per date of the year), degree days, growing degree days, winds, and temperature statistics for a corresponding geographic area. The temperature statistics may include a minimum temperature, a maximum temperature, a mean temperature, and a mode temperature for a corresponding geographic area. The growing degree day and degree day are both based on temperature statistics. The growing degree day is an index that may be used to express or predict crop maturity. The growing degree day may be based on the minimum and maximum temperature for a day with respect to a reference temperature (e.g., 50 degrees for a corn growing degree day) for a corresponding geographic location. A degree day is used to estimate the amount of energy required to maintain a comfortable target indoor temperature in a certain geographic area. A degree day represents that extent that the daily mean temperature falls below or above an indoor target temperature (e.g., 65 degrees).

Weather data refers to forecasted, current, or historic data concerning the weather associated with a geographic area or location. Weather data may be time stamped, and date stamped. The weather data may include measurements and statistics related to temperature, precipitation, sunlight (e.g., visible or ultraviolet light intensity versus time or cumulative light exposure), cloud cover, wind speed, wind direction, and barometric pressure, for instance.

The management practices of a grower may be rated based on one or more of the following factors, among others: (1) use of a reliable precision guidance system (e.g., Global Positioning System (GPS) receiver with differential correction) for greater efficiency (e.g., reduced fuel consumption) in agricultural tasks (e.g., plowing, planting, tilling, seeding, harvesting, spraying, or applying); (2) use of genetically engineered crops or conventional hybrids in compliance with applicable laws and regulations to increase stress resistance, drought resistance, disease resistance, pest resistances, or reduce chemical inputs; (3) use of preferred crop inputs (e.g., pesticides, fungicides, fertilizer, ammonia, nitrogen) with increased safety, lower human toxicity, greater effectiveness or reduced application amounts to achieve effective result or to comply with laws or governmental regulations, (4) use of low-till or no-till farming operations to reduce soil erosion or loss of applied nutrients during the growing season; (5) use of buffer zones or filter strips to reduce soil erosion or loss of applied nutrients during the growing season, (6) use of crop rotations to reduce pesticide requirements (e.g., dosage or application rates) over a multi-year time span; (7) use of legumes to enrich soil with nitrogen for subsequent crops (e.g., corn or wheat); and (8) the use of organic growing practices (e.g., consistent with the Organic Food Production Act of 1990, 7 U.S.C.§§ 6501-6522). For instance, organic growing practices may prohibit the use of synthetic chemicals during a growing season and for three (3) years immediately preceding the harvest of agricultural products, unless an exception applies under applicable law or regulations. Further organic growing practices may require buffer zones between organically cultivated land and land that is not cultivated in accordance with organic operations.

If the particular grower of the particular crop is determined to be suitable for coverage of individualized risk, the method continues with step S106. However, if the first insurance policy is determined to be unsuitable for coverage of individualized risk, the method continues in step S105. Although step S102 comes prior to step S104 in FIG. 1, it is understood that step S102 and S104 may be executed in any order, including a reversed order from that shown in FIG. 2.

In step S105, the particular grower is rejected for individualized protection for the particular crop.

In step S106, the insurer receives an assignment of at least a portion of the indemnification or indemnity payment under the first insurance policy, consistent with the determined suitability.

In step S108, the insurer issues a second insurance policy in exchange for the assigned indemnification to the first crop insurance policy or other consideration. For example, the premium for the coverage may be based on the desired coverage level (e.g., expressed in percent) multiplied by the currency amount of coverage per land unit (e.g., dollar amount of coverage per acre), less any premium subsidy or governmental subsidy received by the insurer by or on behalf of the grower. The second crop insurance policy covers a second risk associated with an average yield or grower revenue of an individual grower within the group of growers. The desired level of protection may be based upon a percentage of a particular grower's historic yield, for example.

In one example for carrying out step S108, the second insurance policy may define the grower's historic yield in terms of a grower's actual production history (APH). The previous discussion of step S106 and step S108 in FIG. 1 applies with equal force to FIG. 2, as if fully set forth here.

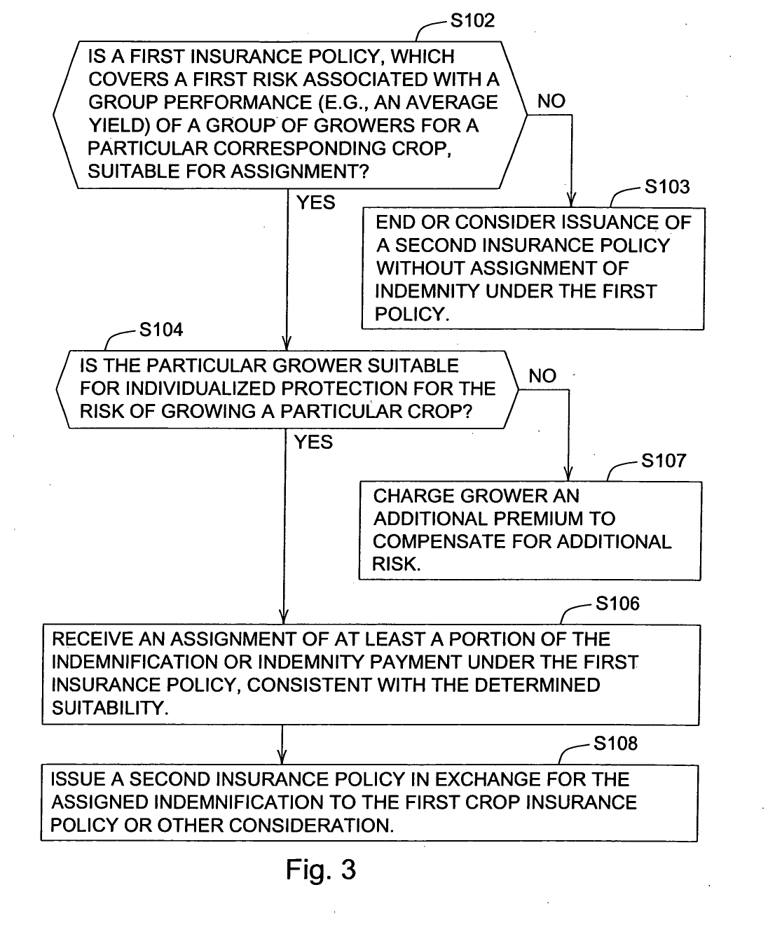

The method of FIG. 3 is similar to the method of FIG. 2, except the method of FIG. 3 replaces step S105 with step S107.

In step S107, the insurer may approve an individual grower for individualized protection under the second insurance policy, if the grower is charged an additional premium (e.g., monetary payment in addition to or instead of the assignment of the indemnity fee) to compensate for additional risk. The amount of the additional premium may be based upon the evaluation of one or more of the factors that are used to determine suitability in step S104, as previously described herein.

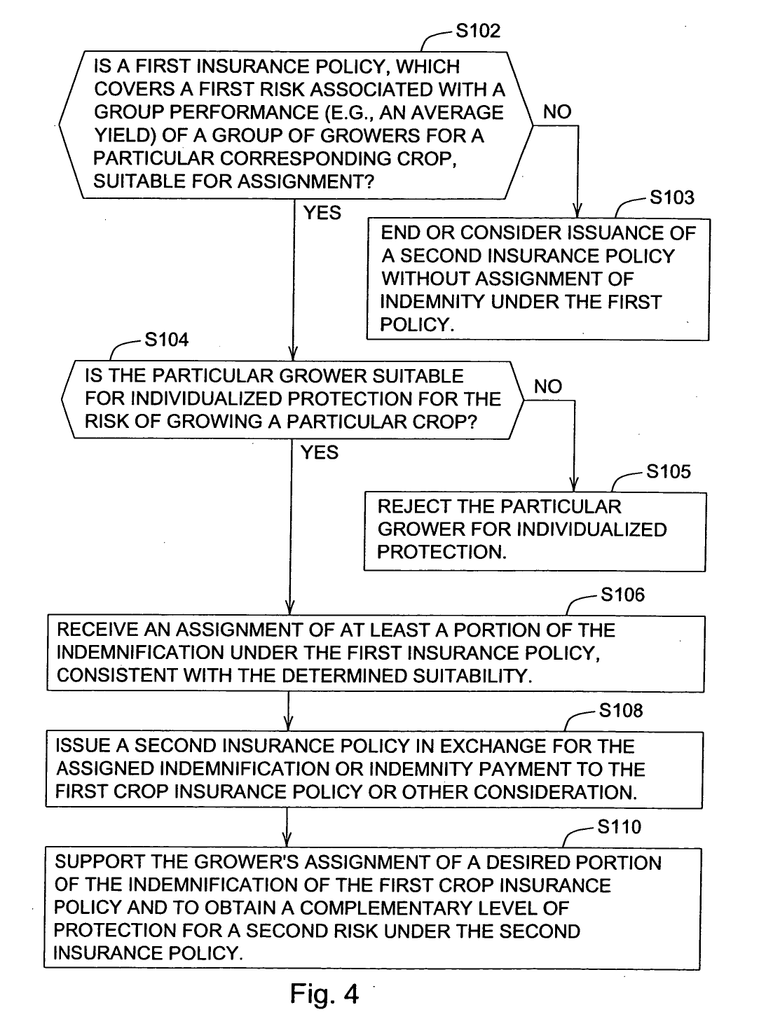

The method of FIG. 4 is similar to the method of FIG. 2, except the method of FIG. 4 further comprises step S110.

In step S100, a grower assigns a desired portion of the indemnification or indemnity payment of the first crop insurance policy to retain a desired level of protection for the first risk (e.g., a group performance risk) under the first crop insurance policy and to obtain a complementary level of protection for a second risk (e.g., individual risk) under the second insurance policy. Although in the past growers were not generally permitted to carry a group risk product (e.g., GRP or GRIP) and actual production history crop insurance (e.g., Actual Production History Protection (APHP), Crop Revenue Coverage (CRC), Income Protection (IP) and Revenue Assurance (RA)) for the same growing season and crop, this inflexible view unfairly places risks on growers that could otherwise be covered. It is anticipated that a hybrid group-individual risk product (consistent with the method of FIG. 4) may gain wide acceptance in the marketplace for crop insurance and risk management products, subject to approval by crop insurance regulators and as permitted under the contractual terms and conditions of the first crop insurance policy. Here, the hybrid group-individual risk product represents a combination of a partial assignment of any indemnity payment under the first crop insurance policy to cover group risk and the issuance of a second crop insurance policy to cover an individual risk. Accordingly, the grower may receive a first indemnity payment if the county yield falls below the trigger yield and a second indemnity payment if the grower yield falls below a target yield or revenue, for instance. The first indemnity payment and the second indemnity payment are not necessarily mutually exclusive.

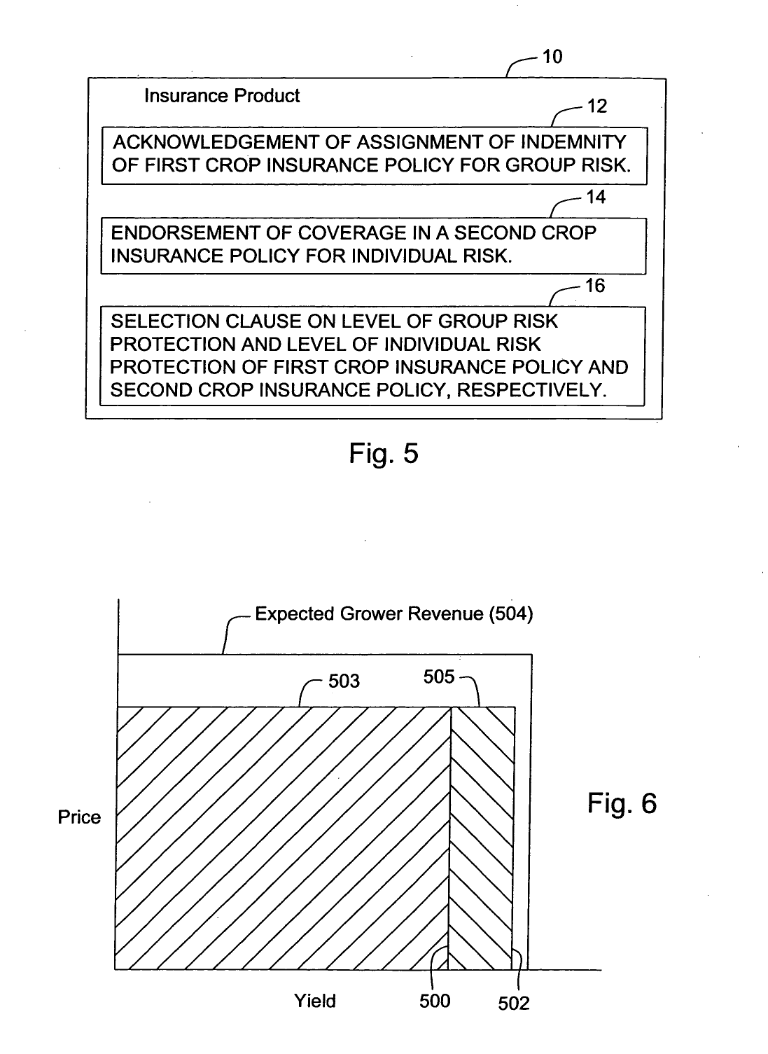

The insurance product of FIG. 5 comprises an acknowledgement of assignment of the indemnity of first crop insurance policy for group risk, an endorsement of coverage in second crop insurance policy for individual risk, and a selection clause on the group level of group risk protection and individual level of individual risk protection of the first crop insurance policy and the second crop insurance policy, respectively. In one embodiment, the acknowledgement 12 of the assignment of the indemnity of the first crop insurance policy relates to an assignment of the indemnity payment to an insurer, an underwriter, or a reinsurer associated with the first crop insurance policy. The endorsement 14 may cover individual risk of a grower growing a particular crop in a manner similar to an MPCI policy, an APH policy, or the like. The endorsement 14 may be based on the grower yield falling below a trigger yield of the individual grower or an actual revenue of the grower for a growing season falling below a trigger revenue. The level of group risk protection may depend upon historic grower performance and whether any additional consideration is received other than assignment of the indemnity payment under the first policy.

FIG. 6 shows a graph of the targeted risk coverage of the first insurance policy and the second insurance policy. The horizontal axis of FIG. 6 shows yield of a particular crop and the vertical axis shows crop price of a particular crop. The first crop insurance policy (e.g., GRP crop insurance policy) is associated with a first protection zone 503, which is generally rectangular as illustrated. The second crop insurance policy (e.g., endorsement to the GRP crop insurance policy) is associated with a second protection zone 505, which is adjacent to the first protection zone. The first protection zone 503 and the second protection zone 505 are distinguished by the different cross-hatching in FIG. 6.

A generally vertical line 500, which separates the first protection zone 503 from the second protection zone 505, represents or is generally indicative of the trigger yield that is covered under the first crop insurance policy. A second generally vertical line 502 which forms an outer boundary of the second protection zone 505 represents the greater yield of the grower that is protected under the second crop insurance policy. The second insurance policy coverage covers a gap between the individual grower yield and the county or group yield, such as where the individual yield falls materially below the county or group yield. The expected grower revenue 504 is depicted by the lines outside of the first risk protection zone 503 and the second risk protection zone 505.

Having described the preferred embodiment, it will become apparent that various modifications can be made without departing from the scope of the invention as defined in the accompanying claims.

We claim:

1. A method for providing risk protection to a grower of a crop, the method comprising:
reviewing a first crop insurance policy covering a first risk associated with an average yield of a group of growers;
receiving an assignment of at least a portion of the indemnification under the first crop insurance policy to an insurer; and
issuing a second crop insurance policy in exchange for the assigned indemnification to the first crop insurance policy, the second crop insurance policy covering a second risk associated with an average yield of an individual grower within the group of growers.

2. The method according to claim 1 further comprising:
allowing a grower to assign a desired portion of the indemnification of the first crop insurance policy to retain a desired level of protection for the first risk under the first crop insurance policy and to obtain a complementary level of protection for a second risk under the second insurance policy.

3. The method according to claim 1 further comprising:
allowing a grower to assign all of the indemnification of the first crop risk insurance policy to protect against an individualized risk of loss under the second crop insurance policy, as opposed to a group risk of loss under the first crop insurance policy.

4. The method according to claim 1 further comprising:
establishing the second crop insurance policy to provide at least one of yield-based protection and revenue-based protection on an individualized basis for a particular grower.

5. The method according to claim 1 wherein the first crop insurance policy comprises at least one of a Group Risk Insurance Policy (GRIP), a Group Risk Protection Policy (GRP), and a Group Risk Income Protection with Harvest Revenue Option (GRIPHRO).

6. The method according to claim 1 further comprising qualifying the grower as a qualified grower eligible to receive the issuance of the second insurance policy if the grower substantially complies with a predicted yield estimate and variance based on at least one of genetics of the particular crop, environment of grower zones associated with the grower, and management practices associated with the grower.

7. A method for providing risk protection to a grower of a crop, the method comprising:
reviewing a first crop insurance policy covering a first risk associated with revenue of a group of growers;
receiving an assignment of at least a portion of the indemnification under the first crop insurance policy to an insurer; and
issuing a second crop insurance policy in exchange for the assigned indemnification to the first crop insurance policy, the second crop insurance policy covering a second risk associated with an average yield of an individual grower within the group of growers.

8. The method according to claim 7 further comprising:
allowing a grower to assign a desired portion of the indemnification of the first crop insurance policy to retain a desired level of protection for the first risk under the first crop insurance policy and to obtain a complementary level of protection for a second risk under the second insurance policy.

9. The method according to claim 7 further comprising:
allowing a grower to assign all of the indemnification of the first crop risk insurance policy to protect against an individualized risk of loss under the second crop insurance policy, as opposed to a group risk of loss under the first crop insurance policy.

10. The method according to claim 7 further comprising:
establishing the second crop insurance policy to provide at least one of yield-based protection and revenue-based protection on an individualized basis for a particular grower.

11. The method according to claim 7 wherein the first crop insurance policy comprises at least one of a Group Risk Insurance Policy (GRIP), a Group Risk Protection Policy (GRP), and a Group Risk Income Protection with Harvest Revenue Option (GRIPHRO).

12. The method according to claim 7 further comprising qualifying the grower as a qualified grower eligible to receive the issuance of the second insurance policy if the grower substantially complies with a predicted yield estimate and variance based on at least one of genetics of the particular crop, environment of grower zones associated with the grower, and management practices associated with the grower.

13. A crop insurance product, the crop insurance product comprising:
an assignment from an insured of at least a portion of the indemnification under a first crop insurance policy associated with an average yield of a group of growers to an insurer; and
a grant of at least one of an endorsement to the first crop insurance policy and a second crop insurance policy to the insured in exchange for the assigned indemnification to the first crop insurance policy, the endorsement or second crop insurance policy covering a second risk associated with an average yield of an individual grower within the group of growers.

14. The insurance product according to claim 13 further comprising:
a selection allowing a grower to assign a desired portion of the indemnification of the first crop risk insurance policy to retain a desired level of protection for the first risk under the first crop insurance policy and to obtain a complementary level of protection for a second risk under the second insurance policy.

15. The insurance product according to claim 13 further comprising:
a selection allowing a grower to assign all of the indemnification of the first crop risk insurance policy to protect against an individualized risk of loss under the second crop insurance policy, as opposed to a group risk of loss under the first crop insurance policy.

16. The insurance product according to claim 13 wherein the second crop insurance policy to provides at least one of yield-based protection and revenue-based protection on an individualized basis for a particular grower.

17. The insurance product according to claim 13 wherein the first crop insurance policy comprises at least one of a Group Risk Insurance Policy (GRIP), a Group Risk Protection Policy (GRP), and a Group Risk Income Protection with Harvest Revenue Option (GRIPHRO).

18. The insurance product according to claim 13 further comprising:
a warranty of the insured that the insured will use a particular crop with corresponding genetic specifications.

19. The insurance product according to claim 13 further comprising:
a warranty of the insured that the insured will adhere to specified management practices for growing the particular crop.
